(19) United States
(12) Patent Application Publication
(10) Pub. No.: US 2021/0258061 A1
(43) Pub. Date: Aug. 19, 2021

(54) BEAM CORRESPONDENCE VERIFICATION FOR WIRELESS NETWORKS

(71) Applicant: Nokia Technologies Oy, Espoo (FI)

(72) Inventors: Johannes Harrebek, Aalborg (DK); Claudio Rosa, Randers NV (DK); Benny Vejlgaard, Gistrup (DK); Mark Cudak, Rolling Meadows, IL (US); Nitin Mangalvedhe, Hoffman Estates, IL (US); Jun Tan, Glenview, IL (US); Frederick Vook, Schaumburg, IL (US); Simon Svendsen, Aalborg (DK)

(21) Appl. No.: 16/792,651

(22) Filed: Feb. 17, 2020

(51) Int. Cl. H04B 7/06; H04W 72/04; H04B 7/0404; H04L 5/00; H04W 52/24; H04W 52/14

(52) U.S. Cl. CPC H04B 7/0695; H04W 72/042; H04B 7/0404; H04W 72/0413; H04W 52/242; H04W 52/146; H04L 5/0048

(57) ABSTRACT

A method may include determining an uplink loss metric for an uplink communication path from a user equipment to a base station in a wireless network based at least on an uplink transmit beam for the user equipment and an uplink receive beam for the base station; determining a downlink loss metric for the downlink communication path from the base station to the user equipment based at least on a downlink transmit beam for the base station and a downlink receive beam for the user equipment; and determining, based on the uplink loss metric and the downlink loss metric, an uplink/downlink beam correspondence misalignment for the user equipment that indicates that the uplink transmit beam for the user equipment is misaligned with the downlink receive beam for the user equipment. For example, see FIGS. 5-6.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include determining an uplink loss metric for an uplink communication path from a user equipment to a base station in a wireless network based at least on an uplink transmit beam for the user equipment and an uplink receive beam for the base station; determining a downlink loss metric for the downlink communication path from the base station to the user equipment based at least on a downlink transmit beam for the base station and a downlink receive beam for the user equipment; and determining, based on the uplink loss metric and the downlink loss metric, an uplink/downlink beam correspondence misalignment for the user equipment that indicates that the uplink transmit beam for the user equipment is misaligned with the downlink receive beam for the user equipment.

An apparatus may include means for determining an uplink loss metric for an uplink communication path from a user equipment to a base station in a wireless network based at least on an uplink transmit beam for the user equipment and an uplink receive beam for the base station; means for determining a downlink loss metric for the downlink communication path from the base station to the user equipment based at least on a downlink transmit beam for the base station and a downlink receive beam for the user equipment; and means for determining, based on the uplink loss metric and the downlink loss metric, an uplink/downlink beam correspondence misalignment for the user equipment that indicates that the uplink transmit beam for the user equipment is misaligned with the downlink receive beam for the user equipment.

A non-transitory computer-readable storage medium comprising instructions stored thereon that, when executed by at least one processor, are configured to cause a computing system to determine an uplink loss metric for an uplink communication path from a user equipment to a base station in a wireless network based at least on an uplink transmit beam for the user equipment and an uplink receive beam for the base station; determine a downlink loss metric for the downlink communication path from the base station to the user equipment based at least on a downlink transmit beam for the base station and a downlink receive beam for the user equipment; and determine, based on the uplink loss metric and the downlink loss metric, an uplink/downlink beam correspondence misalignment for the user equipment that indicates that the uplink transmit beam for the user equipment is misaligned with the downlink receive beam for the user equipment.

An apparatus including at least one processor, and at least one memory including computer program code, the at least one memory and the computer program code configured to, with the at least one processor, cause the apparatus at least to determine an uplink loss metric for an uplink communication path from a user equipment to a base station in a wireless network based at least on an uplink transmit beam for the user equipment and an uplink receive beam for the base station; determine a downlink loss metric for the downlink communication path from the base station to the user equipment based at least on a downlink transmit beam for the base station and a downlink receive beam for the user equipment; and determine, based on the uplink loss metric and the downlink loss metric, an uplink/downlink beam correspondence misalignment for the user equipment that indicates that the uplink transmit beam for the user equipment is misaligned with the downlink receive beam for the user equipment.

A method may include sending, by a base station to a user equipment, a request for an uplink/downlink beam correspondence misalignment measurement for the user equipment; sending, by the base station, downlink reference signals; sending, by the base station to the user equipment, information indicating a base station transmit power used by the base station to transmit the downlink reference signals, and a threshold value to be used by the user equipment to determine an uplink/downlink beam correspondence misalignment for the user equipment that indicates that an uplink transmit beam for the user equipment is misaligned with the downlink receive beam for the user equipment; determining, by the base station, a base station measured receive power of the uplink reference signals received by the base station from the user equipment; sending, by the base station to the user equipment, information indicating at least the base station receive power of the uplink reference signals; and receiving, by the base station from the user equipment, a message indicating the uplink/downlink beam correspondence misalignment for the user equipment.

A method may include receiving, by a user equipment from a base station, a request for an uplink/downlink beam correspondence misalignment measurement for the user equipment; sending, by the user equipment, uplink reference signals; determining, by the user equipment, a user equipment measured receive power of the downlink reference signals received by the user equipment from the base station; sending, by the user equipment to the base station, information indicating a user equipment transmit power used by the user equipment to transmit the uplink reference signals, and the user equipment receive power of the downlink reference signals; and receiving, by the user equipment from the base station, a message indicating an uplink/downlink beam correspondence misalignment for the user equipment that indicates that an uplink transmit beam for the user equipment is misaligned with a downlink receive beam for the user equipment. In an example embodiment, the method may further include the UE performing a corrective action (e.g., in cooperation with the BS/gNB) to improve the uplink/downlink beam correspondence alignment for the user equipment, in response to the message indicating the uplink/downlink beam correspondence misalignment for the user equipment.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating an example beam alignment procedure according to an example embodiment.

FIG. 3 is a diagram illustrating beams according to an example embodiment.

FIG. 4 is a diagram illustrating one or more parameters or measurements that may be associated with an uplink loss metric, and one or more parameters or measurements that may be associated with a downlink loss metric, according to an example embodiment.

FIG. 5 is a flow chart illustrating a procedure for a base station or gNB to perform calculation of uplink and downlink loss metrics, and to determine an UL/DL beam correspondence misalignment according to an example embodiment.

FIG. 6 is a flow chart illustrating a procedure for a user equipment/user device to perform calculation of uplink and downlink loss metrics, and to determine an UL/DL beam correspondence misalignment according to an example embodiment.

FIG. 7 is a flow chart illustrating operation of a user equipment/user device or base station/gNB or other node according to an example embodiment.

FIG. 8 is a flow chart illustrating operation of a base station according to another example embodiment.

FIG. 9 is a flow chart illustrating operation of a user device/user equipment according to another example embodiment.

FIG. 10 is a block diagram of a wireless node or wireless station (e.g., AP, BS, gNB, eNB, RAN node, UE or user device, or other node) according to an example embodiment.

### DETAILED DESCRIPTION

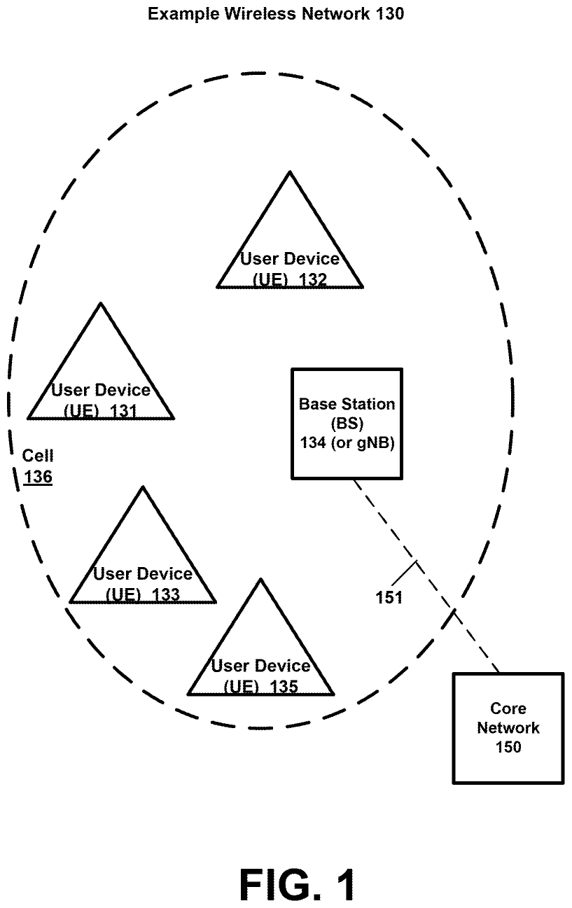

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

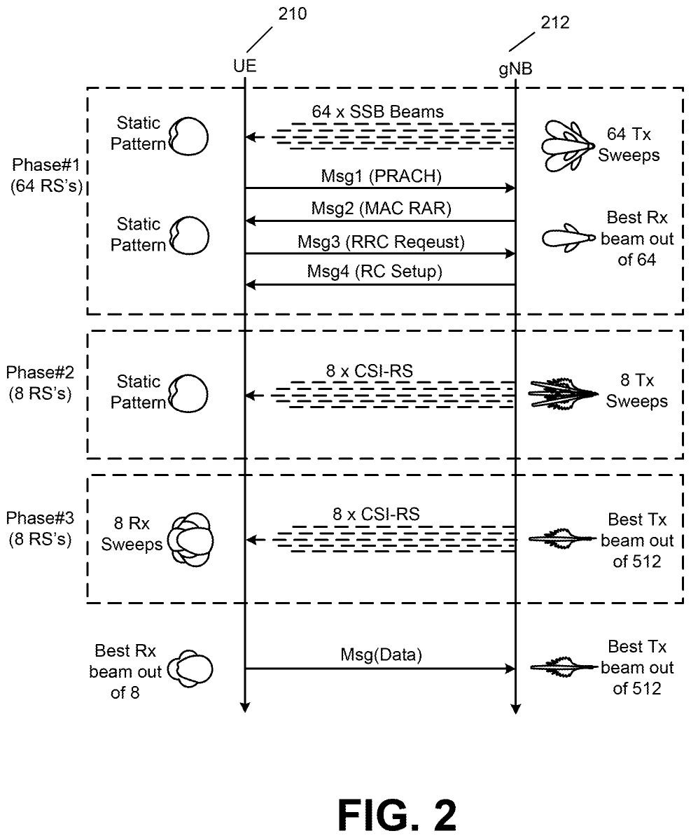

FIG. 2 is a diagram illustrating an example beam alignment procedure according to an example embodiment. A UE 210 may be in communication with a gNB 212 and/or may establish a communication link between UE 210 and gNB 212. Three phases are shown for a beam alignment procedure that allows UE 210 and gNB 212 to select a narrow beam for the UE-gNB communication link.

Phase #1: UE 210 is configured for broad (wide) beam receiving (receiving reference signals via a wide receive beam), while gNB 212 is performing downlink (DL) SSB (synchronization signal block) beam sweeping. UE measures the reference signal received power (RSRP) for all of the (up to) 64 SSB beams. At random access, the UE indicates to gNB 212 the best SSB beam (i.e., the SSB beam having a highest RSRP as measured by UE) by transmitting a random access preamble on physical random access resources that are associated to the corresponding SSB beam, and using same beam configuration as in receiving. Thus, according to an example embodiment, Phase #1: UE is configured for broad beam RX while gNB is performing DL (downlink) SSB beam sweeping. UE measures received power (e.g., RSRP) for all SSB beams received and indicates to gNB the best (or strongest or highest power) SSB beam by transmitting a random access preamble on physical random access resources that are associated to the corresponding SSB beam, and using same beam configuration as in RX. Thus, for example, at Phase #1, the gNB 212 sweeps its beam, and UE 210 uses a wide beam to measure RSRP for each gNB beam, and UE reports back the strongest (or highest power) gNB beam via random access procedure. Thus, in phase #1, the UE receives and measures signals using a static or wide UE receive beam.

Phase #2: UE 210 is configured for broad beam receiving, while gNB is performing refined downlink (DL) channel state information-reference signal (CSI-RS) (or narrow beam) beam sweeping, in which a CSI-RS signal is transmitted for each of the 8 CSI-RS (or narrow) beams of the gNB. UE measures RSRP (or other metric, e.g., SINR) for all CSI-RS beams received and reports the best CSI-RS (e.g., the CSI-RS in correspondence of which the UE measures the highest RSRP or SINR) back to gNB 212 using same beam configuration as in receiving. Thus, at phase #2, gNB 212 sweeps through a set of CSI-RS narrow beams, and UE 210 reports back to gNB 212 the best or strongest CSI-RS/narrow beam.

Phase #3: gNB 212 continues transmitting CSI-RS using its best (or highest power) narrow transmit beam found in Phase #2, and UE 210 sweeps through its narrow receive beams or refined receive beams so the UE 210 may determine its best UE narrow receive beam that is aligned with the gNB narrow transmit beam. The UE may perform this by selecting the UE narrow receive beam where the UE measures the highest RSRP/SINR on CSI-RS. At the end of three phase alignment between gNB 212 and UE 210 illustrated in FIG. 2, the selected (best) gNB narrow transmit beam is pointed towards the UE (e.g., within a threshold of accuracy), and the best or selected (highest power) UE narrow receive beam is pointed (e.g., within a threshold) towards (or aligned with) the gNB narrow transmit beam (or pointed from the UE 210 back towards the gNB 212). Thus, after the beam alignment procedure, it may be assumed, for example, that the (e.g., best or highest RSRP) UE narrow receive beam (for this UE-gNB communications link) is aligned with the (selected or highest power) gNB narrow transmit beam for the UE-gNB communications link Thus, at the end of the three phase beam alignment illustrated in FIG. 2, an alignment (e.g., within a threshold amount) may be obtained between the gNB narrow DL transmit beam and the UE narrow DL receive beam, and this pair of beams may provide, e.g., for maximized directional gain for communications between the UE 210 and gNB 212, and may provide for a reduced (e.g., minimized) interference on other users or UEs in serving cell and neighbor cells.

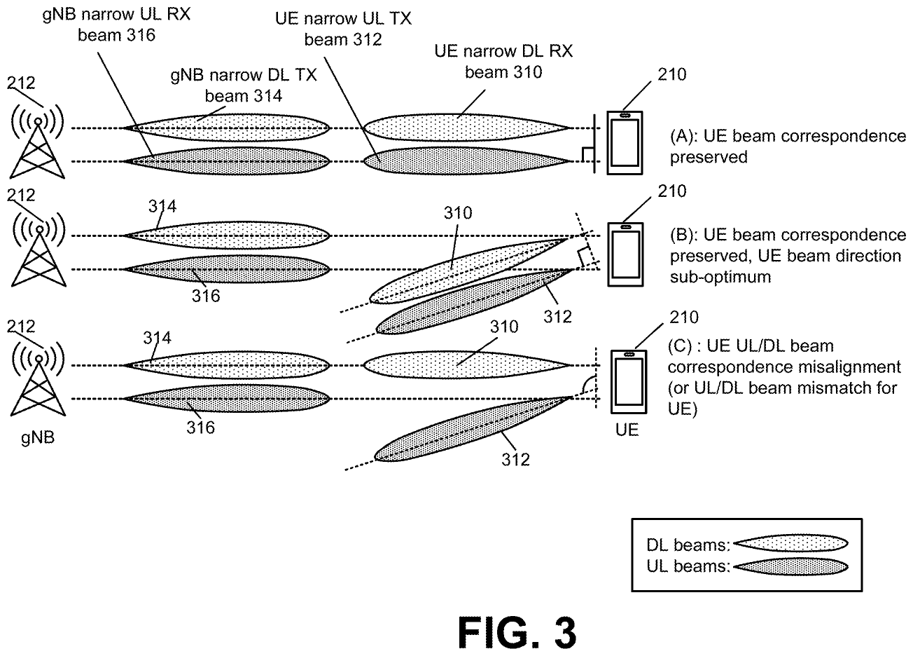

FIG. 3 is a diagram illustrating beams according to an example embodiment. The example beam alignment procedure as depicted in FIG. 2 may be used, for example, to align the UE downlink receive beam 310 (see beams illustrated in FIG. 3) with the gNB downlink transmit beam 314 (FIG. 3). However, one or more conditions or situations may arise that may cause UE beam misalignment, e.g., where the UE downlink receive beam is no longer aligned with (or points towards) the gNB downlink transmit beam for the UE-gNB communications link.

In an example embodiment, the example beam alignment procedure as depicted in FIG. 2 may align the UE downlink receive beam 310 (FIG. 3) with the gNB downlink transmit beam 314. For this alignment procedure to be adequate for the UE (and thus, to align both UE beams 310, 312, to correctly point towards the gNB), UL/DL beam correspondence is assumed (or should be present) on both gNB and on UE side, i.e., the optimum UL beam setting (or beam weights or beam configuration) can be derived from the DL beam setting. An example of UL/DL beam correspondence is depicted in case (A) and case (B) of FIG. 3, where the UE UL transmit beam 312 is aligned with (or points in the same direction as) the UE DL receive beam 310. Thus, for example, UE UL/DL beam correspondence alignment may refer to alignment (e.g., both beams pointing in the same direction, within a threshold value) of the UE UL transmit beam 312 with the UE DL receive beam 310. A failure to correctly align the UE UL transmit beam 312 may result in poor performance (e.g., increased errors or a higher error rate, low signal to interference plus noise ratio or other poor performance) at the gNB for UE signals transmitted to the gNB.

In an illustrative example embodiment, UL/DL beam correspondence may be preserved if (for example): 1) Using identical antenna element weights for DL & UL result in same (within a threshold) beam gain and beam direction for DL & UL; and/or 2) Antenna element weights can be offset by pre-characterized (or known) values to obtain same (within a threshold) beam gain and beam direction for DL & UL (or otherwise the antenna weights are known for the UL beam and DL beam for the UE, that provides for beam correspondence alignment).

In an illustrative example, if 1) and/or 2) above is not fulfilled, then UL/DL beam correspondence alignment may not be present (and UL/DL beam correspondence misalignment may be present), e.g., as shown in the example of case (C) of FIG. 3.

While careful design and characterization aims at securing UL/DL beam correspondence alignment (e.g., alignment of UE UL transmit beam with the UE DL receive beam, within a threshold) there may be one or more factors that may impact UE UL/DL beam correspondence alignment, e.g., even dynamically in the field. As an illustrative example, some problems in beam correspondence alignment may arise when an antenna load (e.g., UE antenna load) is changing between DL and UL to the extent that it starts to significantly impact the beam direction for fixed antenna array weights. For such a case, in an example embodiment, the problem or misalignment may increase with frequency as beams are getting narrower with associated increased demand for high beam directional accuracy for a sustained link budget.

According to an illustrative example embodiment, various loading effects may impact UL/DL beam correspondence alignment (e.g., dynamically in the field) and which may not necessarily be compensated by characterization, such as for example: External load mismatch (e.g., different antenna load for the UE UL and DL beams, and/or for BS UL and DL beams); Load variation vs transmit (TX) power level (e.g., different load levels for different transmission power levels); Load variation vs bandwidth (e.g., different antenna loads for different bandwidths); Load variation vs temperature (e.g., different antenna loads at different temperatures); Load variation vs battery voltage (e.g., antenna load may change based on UE voltage level, such as when UE battery charge decreases or varies over time).

FIG. 3 is a diagram illustrating beams according to an example embodiment. FIG. 3 illustrates three cases, including case (A), case (B), and case (C). The case of beam alignment between gNB and UE in both UL (uplink) and DL (downlink) direction with UL/DL beam correspondence (including UE UL/DL beam correspondence alignment) preserved is shown in case (A) of FIG. 3. Case (B) of FIG. 3 shows a case with UL/DL beam correspondence preserved (UE UL/DL beam correspondence alignment) but with suboptimum (e.g., erroneous, inaccurate or incorrect) UE downlink beam direction. Case (C) of FIG. 3 shows a case of UE UL/DL beam correspondence misalignment.

As shown in FIG. 3, in case (A), four beams are shown, including a UE downlink (DL) receive (RX) beam 310, a UE uplink (UL) transmit (TX) beam 312, a gNB DL transmit beam 314, and a gNB UL receive beam 316. Example beams are shown, and any type or any width of beams may be used. As shown in FIG. 3, the UE DL receive beam 310 points towards gNB 212 or towards gNB DL transmit beam 314, and the UE UL transmit beam 312 points towards gNB 212 or towards gNB UL receive beam 316. Thus, in case (A) of FIG. 3, both of the UE UL transmit beam 312 and UE DL receive beam 310 are aligned with gNB 212 (or aligned with beams of gNB 212). There is beam correspondence alignment for the UE 210 because the UE UL transmit beam 312 is aligned with (or points in the same direction as) the UE DL receive beam 310 (e.g., both of the UE UL transmit beam 312 and DL receive beam 310 point along the same line or direction, and thus are aligned, within a threshold). In case (B), UE UL/DL beam correspondence alignment exists (e.g., because the UE UL transmit beam 312 points along the same line or direction as the UE DL receive beam 310). However, the UE beams 310, 312 are pointed to a direction that is sub-optimum (e.g., not pointed to the gNB 212 or gNB beams) In case (C), the UE DL receive beam 310 is aligned with the gNB 212 or aligned with the gNB DL transmit beam 314. However, UE UL/DL beam correspondence misalignment is present in case (C), e.g., because the UE UL transmit beam 312 is not aligned with the UE DL receive beam 310, within a threshold. As noted, various conditions may have caused the UE UL/DL beam correspondence misalignment, which may impact or reduce communication performance from the UE 210 to the gNB 212.

Therefore, a UE may be in communication with a BS (e.g., gNB), and/or may have established a connection between the UE and the BS/gNB. According to an example embodiment, a technique(s) or embodiment(s) may be provided that allow the UE and/or the BS/gNB to detect (or determine) a UE UL/DL beam correspondence misalignment for the UE. In an illustrative example embodiment, detection of a UE UL/DL beam correspondence misalignment may be based on a downlink (DL) loss metric (e.g., a DL loss metric that may be associated with a DL communication path from the gNB to the UE), and an uplink loss metric (e.g., an UL loss metric that may be associated with an UL communication path from the UE to the gNB). According to an example embodiment, different types of loss metrics (e.g., measured in different ways, or based on different parameters or measurements) may be used for a DL loss metric and an UL loss metric. According to an example embodiment, a comparison (e.g., by comparing, or by performing a subtraction or taking a difference) of the UL loss metric and the DL loss metric may provide an indication of (or may be used to detect/determine) an UL/DL beam correspondence misalignment for the UE. In an illustrative example embodiment, a difference (e.g., such as an absolute value of a difference) of an UL loss metric and a DL loss metric may be compared to a threshold (or threshold value) to determine whether or not a UL/DL beam correspondence misalignment is present for the UE. According to an example embodiment, if there is UE UL/DL beam correspondence alignment, then it may be expected that an absolute value of a difference between the DL loss metric and the UL loss metric may be small or negligible, e.g., within a threshold value (the absolute value of the difference of the loss metrics would be less than the threshold value). Likewise, for example, if there is UE UL/DL beam correspondence misalignment (e.g., as an example, see FIG. 3, case (C) where UE UL TX beam 312 is not aligned, or is misaligned, with UE DL receive beam 310), the absolute value of the difference between the DL loss metric and the UL loss metric may be expected to be greater than the threshold value.

In an example embodiment, a downlink (DL) loss metric may be or may include a metric (e.g., measurement, barometer, estimation, representation, or other indication) associated with the DL communication path from the gNB to the UE. For example, the DL loss metric may be based on one or more parameters or measurements that may be associated with (e.g., such as which may be used to determine) the DL pathloss for the DL communication path. In an example embodiment, the DL loss metric may indicate or estimate a DL pathloss for the DL communication path, or the DL loss metric may merely be associated with or may represent (in some way) the DL pathloss for the DL communication path. Other types of DL loss metrics may be used as well. In an illustrative example embodiment, where the DL loss metric may be associated with the DL pathloss, the DL loss metric may, for example, be based on only some (e.g., one or more, and/or less than all) of the measurements or parameters that may be used to determine a DL pathloss for the DL communication path (e.g., such as one or more of a gNB transmit power to transmit DL reference signals, a DL gNB transmit antenna gain, a DL UE antenna gain, and/or a UE measured DL receive power of the DL reference signals transmitted by the gNB, or other measurements or parameters). Thus, according to an example embodiment, a DL loss metric may include a metric associated with the DL communication path from the gNB to the UE, and for example, may be based on one or more parameters or measurements that may be associated with a DL pathloss for the DL communication path.

In an example embodiment, an uplink (UL) loss metric may be or may include a metric (e.g., measurement, barometer, estimation, representation, or other indication) associated with the UL communication path from the UE to the gNB. For example, the UL loss metric may be based on one or more parameters or measurements that may be associated with (e.g., such as which may be used to determine) the UL pathloss for the UL communication path. In an example embodiment, the UL loss metric may indicate or estimate an UL pathloss for the UL communication path, or the UL loss metric may merely be associated with or may represent (in some way) the UL pathloss for the UL communication path. Other types of UL loss metrics may be used as well. In an illustrative example embodiment, where the UL loss metric may be associated, in some way, with the UL pathloss, the UL loss metric may, for example, be based on only some (e.g., one or more, and/or less than all) of the measurements or parameters that may be used to determine an UL pathloss for the UL communication path (e.g., such as one or more of a UE transmit power to transmit UL reference signals, an UL UE transmit antenna gain, an UL gNB receive antenna gain, and/or a gNB measured UL receive power of the UL reference signals transmitted by the UE, or other measurements or parameters). Thus, according to an example embodiment, an UL loss metric may include a metric associated with the UL communication path from the UE to the gNB, and for example, may be based on one or more parameters or measurements that may be associated with an UL pathloss for the UL communication path. In an example embodiment, pathloss (or path loss), which may also be referred to as path attenuation, may include or may refer to a reduction (or attenuation) in power or power density of a radio signal or electromagnetic wave as it is transmitted by a wireless node, propagates through space, and is received by another wireless node.

In an example embodiment, one or more techniques may be used by a UE and gNB/BS to select UL and/or DL beams for communication. For example, the beam alignment procedure may be used by gNB 212 and UE 210 (FIG. 3) to allow the gNB and UE to select appropriate transmit beams and receive beams. Once a beam alignment procedure is performed, at least in some cases, it may be assumed that the UE DL receive beam 310 is aligned with the gNB DL transmit beam 314. And, if there is UL/DL beam correspondence alignment for the UE, the UE UL transmit beam 312 will also be aligned with the UE DL receive beam 310. However, as noted, various conditions may cause a UE UL/DL beam correspondence misalignment. Various techniques are described herein that may allow a UE or gNB/BS to detect (or determine) a UL/DL beam correspondence misalignment for the UE, e.g., based on a DL loss metric for the communication path from the gNB/BS to the UE, and an UL loss metric for the communication path from the UE to the gNB/BS.

According to an example embodiment, a method (e.g., which may be performed by the UE or the gNB) may include: determining an uplink loss metric for an uplink communication path from a UE (e.g., 210, FIG. 3) to a gNB/BS (e.g., 212) in a wireless network based at least on an uplink transmit beam (e.g., UE UL transmit beam 312) for the UE and an uplink receive beam (gNB UL receive beam 316) for the gNB; determining a downlink loss metric for the downlink communication path from the gNB to the UE based at least on a downlink transmit beam (gNB DL transmit beam 314) for the gNB and a downlink receive beam (e.g., UE DL receive beam 310) for the UE; and determining, based on the uplink loss metric and the downlink loss metric, an uplink/downlink (UL/DL) beam correspondence misalignment for the UE that indicates that the uplink transmit beam for the UE is misaligned with the downlink receive beam for the UE.

In an example embodiment, the method may include receiving a message including at least one of the following: an indication of a measured receive power of reference signals transmitted in a first direction (e.g., UL or DL direction), and a transmit power of reference signals transmitted in a second direction (e.g., DL or UL); and wherein at least one of the determining the uplink loss metric and the determining the downlink loss metric is determined, based at least in part, on at least one of the measured receive power of reference signals transmitted in the first direction or the transmit power of reference signals transmitted in the second direction. Thus, for example, one way to determine a loss metric may include taking into account (or considering) transmit power and a measured receive power (and possibly one or more antenna gains). The measured receive power and/or transmit power may need to be provided or sent to the other node (e.g., from UE to gNB, or from gNB to UE), to allow the other node to determine a loss metric.

In an example embodiment, the determining an uplink/downlink beam correspondence misalignment for the user equipment may include: determining an absolute value of a difference between the downlink loss metric and the uplink loss metric; and determining that the absolute value of the difference between the downlink loss metric and the uplink loss metric is greater than a threshold value.

According to an example embodiment, techniques are provided for detection of UE UL/DL beam correspondence misalignment. According to an example embodiment, for an UL/DL beam correspondence aligned scenario the UL and DL path losses should be equal, within a threshold, at any given point in time (e.g., within the channel coherence time and assuming TDD). Also, for example, the DL loss metric and UL loss metric for the UE and gNB should also be equal, within a threshold, for an UL/DL beam correspondence aligned situation. An example embodiment may include the following:

Pre-verification: As an initial step prior to UL/DL correspondence verification, a UE DL beam alignment verification may be conducted. As an illustrative example, the beam alignment procedure shown in FIG. 2 may be performed to confirm the UE DL beam alignment towards the gNB. Thus, for example, a procedure may be used to confirm that the DL beams are aligned for gNB and UE.

gNB: Initiation of measurement. At any given time (e.g., selected by serving gNB) an UL/DL beam misalignment measurement may be initiated by gNB. This may be triggered, for example, based upon gNB experiencing poor UL quality despite a confirmed DL beam alignment.

gNB->UE: Measurement request. gNB requests the UE to perform required measurements: (the gNB may transmit DL reference signals to be measured by the UE, and the UE may transmit UL reference signals to be measured by the gNB):
Request for UE to measure and report UE measured DL receive power (e.g., DL RSRP) of the DL reference signals, and the UE UL transmit (TX) power used by the UE to transmit UL reference signals;
The request may include DL/UL RS and/or time configuration, including information on the reference signal (RS) and when the UE shall perform DL RSRP measurements and/or UL RS transmissions.

UE: UE measures the UE measured receive power (DL RSRP) for the DL reference signals received by the UE from the gNB (need to be measured on RS used for logged/recorded gNB DL transmit power);

gNB: gNB measures the gNB measured UL receive power (UL RSRP) for the UL reference signals received by the gNB from the UE (need to be measured on RS used for logged/recorded UE UL transmit power). For example, the UE measurement of the receive power of the DL reference signals, and the gNB measurement of the receive power of the UL reference signals, should be performed within a channel coherence time period, e.g., to ensure the path losses and/or changes in any of the parameters, as between UL path and DL path, are not due to changes in the channels.

UE->gNB: Measurement reporting. The UE reports back to serving gNB the measured UE measured DL receive power (DL_RSRP) and information on the used UL transmit Power in correspondence of UL RS.

gNB: Calculations. gNB calculates the required comparison metrics (DL loss metric, UL loss metric), e.g., based on below listed parameters and arrives at a beam correspondence verdict, indicating whether there is UE UL/DL beam correspondence alignment, or UE UL/DL beam correspondence misalignment. If a UE UL/DL beam correspondence misalignment is determined (e.g., detected), then a corrective action may be performed (e.g., by the UE and/or gNB) to improve alignment between the UE UL transmit beam and the UE DL receive beam.

An example corrective action may include, for example: transmitting, by the UE to the gNB/BS, uplink reference signals via a plurality of uplink transmit beams; and receiving, by the UE from the gNB based on measurements of the uplink reference signals, information indicating a strongest or best (or appropriate) uplink transmit beam for the UE.

Another example corrective action may include, for example: receiving, by the gNB from the UE, uplink reference signals via a plurality of uplink transmit beams; determining, by the gNB, a strongest or best (or appropriate) uplink transmit beam for the UE; and sending, by the gNB to the UE, information indicating the strongest or best (or appropriate) uplink transmit beam for the UE.

According to an example embodiment, the UE and/or the gNB may include (or may use) an antenna (or an antenna array) that may include a plurality of antenna elements, which may be provided as antenna patches, for example. Such an antenna (or antenna array) may allow narrow high beam gains, both for transmission and reception of signals. For example, at the UE, there may be a UE DL antenna gain for received DL signals, and a UE UL antenna gain for transmission of UL signals. Likewise, at the gNB, there may be a gNB UL antenna gain for received UL signals, and a gNB DL antenna gain for transmission of DL signals. In some example embodiments, one or more of the antenna gains (e.g., at the UE and/or gNB) may be included in a calculation of loss metrics.

Parameters:

DL Parameters: (e.g., one or more of these may be used to determine DL loss metric (DL_Loss_Metric)): gNB DL transmit Power (DL_gNB_Power); DL gNB antenna gain (DL_gNB_Ant_Gain), used to transmit the DL reference signals); UE measured DL receive power (DL_RSRP) of the DL reference signals received by the UE.

UL Parameters: (e.g., one or more of these may be used to determine a UL loss metric (UL_Loss_Metric)): UE UL transmit power (UL_Power), used by UE to transmit the UL reference signals), UL gNB antenna gain (UL_gNB_Ant_Gain), used to receive the UL reference signals); gNB measured UL receive power (UL_RSRP) for the UL reference signals received by the gNB. Also, in the loss metric calculations, in some cases, the gNB antenna gains may be ignored, e.g., if they are the same or very close.

Validation threshold—e.g., a threshold value used to compare the loss metrics or used to analyze a difference between the loss metrics, e.g., in order to estimate whether there is a UE UL/DL beam correspondence misalignment.

Also, in an example embodiment, the UE antenna (or antenna array) may include antenna phase shifters to shift or adjust a phase of the beams. In an example embodiment, the UE antenna (or antenna array) may have a finite (or limited) granularity on the antenna array phase shifters, and thus, a finite or limited resolution on beam angles or resolution. Thus, an acceptable amount of difference between the UL and DL loss metrics (before that will be considered a UE UL/DL beam correspondence misalignment) may take into account (or may be based on) UE antenna or beam performance limitations, e.g., such as the number of beams, beam resolution, beam width or angle between adjacent beams, or other antenna performance parameter(s) of the UE. As an illustrative example, a validation threshold may be appropriately selected (e.g., the gNB/BS, network, or the UE) given the performance parameters and/or performance limitations of the UE antenna. Thus, in an example embodiment, the UE may send to the gNB/BS (e.g., as a UE capability, or within other message or signal) a beam or antenna performance parameter(s) (e.g., which may indicate a number of beams, beam resolution, beam width or angle between adjacent beams, or other beam or antenna performance parameter(s) or limitations of the UE antenna/antenna array), e.g., so that the gNB/BS may select an appropriate validation threshold for the UE that is tailored to (or based upon) the specific performance limitations of the UE.

Calculations:
DL_Loss_Metric=DL_gNB_Power+DL_gNB_Ant_Gain−DL_RSRP
UL_Loss_Metric=UL_Power+UL_gNB_Ant_Gain−UL_RSRP
if |DL_Loss_Metric−UL_Loss_Metric|<=threshold->UE UL/DL beam correspondence alignment is preserved;
if |DL_Loss_Metric−UL_Loss_Metric|>threshold-> there is UE UL/DL beam correspondence misalignment. (UE UL/DL beam correspondence alignment is broken).

gNB<->UE: In this case, where the gNB calculates the loss metrics and determines if there is UE UL/DL beam correspondence misalignment, the gNB sends a message to the UE to deliver beam correspondence verdict report to UE (e.g., indicating whether or not there is UE UL/DL beam correspondence alignment).

gNB & UE: In case of a UE UL/DL beam correspondence misalignment, the UE and/or gNB may perform one or more corrective actions, e.g., to improve UE UL/DL beam correspondence alignment.

Thus, according to an example embodiment, the UE UL/DL beam correspondence misalignment detection technique(s) described herein may make use of the fact that the UL path loss and the DL path loss should be the same or close (within a threshold), within the channel coherence time period, if there is UE UL/DL beam correspondence alignment. Likewise, the DL loss metric and the UL loss metric, which may be based on one or more of the parameters or measurements associated with the DL path loss and UL path loss measurements, respectively, should also be the same or within a threshold, if there is UE UL/DL beam correspondence alignment.

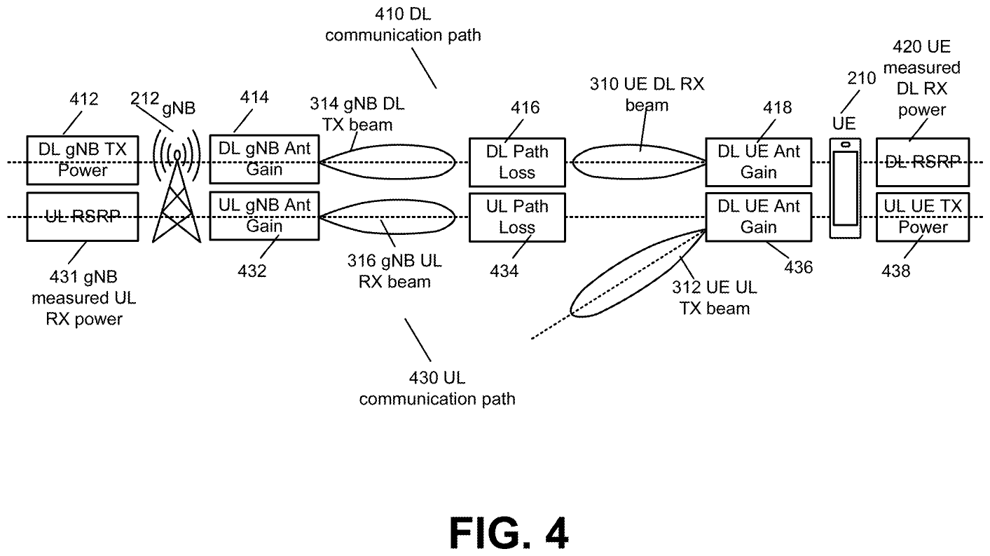

FIG. 4 is a diagram illustrating one or more parameters or measurements that may be associated with an uplink loss metric, and one or more parameters or measurements that may be associated with a downlink loss metric, according to an example embodiment. A UE 210 may be in communication with a gNB 212, including via a DL communication path 410, and a via an UL communication path 430.

For the DL communication path 410, the gNB may transmit signals (e.g., reference signals) via a gNB DL transmit beam 314, and such reference signals may be received by UE 210 via a UE DL receive beam 310. For example, the gNB 212 may transmit the DL reference signals at a DL gNB transmit power 412, and based on a DL gNB antenna gain 414. A DL path loss 416 may be unknown, and may be estimated, at least in some cases. At the UE 210, the DL reference signals may be received by UE 210 via a DL UE antenna gain 418, and the UE 210 may measure the UE measured receive power 420 of the DL reference signals.

For the UL communication path 430, the UE 210 may transmit signals (e.g., reference signals) via a UE UL transmit beam 312 (e.g., which may be misaligned), and such UL reference signals may be received by gNB 212 via a gNB UL receive beam 316. For example, the UE 210 may transmit the UL reference signals at a UL UE transmit power 438, and based on a UL UE antenna gain 436. A UL path loss 434 may be unknown, and may be estimated, at least in some cases, based on the parameters described herein. At the gNB 212, the UL reference signals may be received by gNB 212 via an UL gNB antenna gain 432, and the gNB 212 may measure the gNB measured receive power 431 of the UL reference signals. In some cases, the antenna gains may be included in the pathloss calculations and/or the loss metric calculations, or may be omitted.

Some Example Assumptions that may apply, at least in some cases, for example:
The UL and DL path losses are equal (e.g., within a threshold) for beam correspondence alignment;
The UE UL and DL antenna gain may be equal in beam correspondence mode of operation (for UE);

(and thus, for example, the UE antenna gains may be ignored, or omitted);
The gNB UL and DL antenna gain may be different but the gNB antenna gains/gain delta is known to the gNB.

In an example embodiment, an UL path loss and/or a DL path loss may be determined or calculated as follows:

DL_Path_Loss=DL_gNB_Power+DL_gNB_Ant_Gain+DL_UE_Ant_Gain−DL_RSRP

UL_Path_Loss=UL_UE_Power+UL_UE_Ant_Gain+UL_gNB_Ant_Gain−UL_RSRP

From which the following two loss metrics can be derived or determined for comparison:

DL_Loss_Metric=DL_gNB_Power+DL_gNB_Ant_Gain−DL_RSRP

UL_Loss_Metric=UL_UE_Power+UL_gNB_Ant_Gain−UL_RSRP

Thus, above equations provide example calculations that may be used to determine a DL loss metric and an UL loss metric. These loss metrics (e.g., or a comparison of the UL loss metric and the DL loss metric) may be used to determine whether a UE UL/DL beam correspondence misalignment is present.

According to an example embodiment, as noted, a system may be provided at the UE and at the gNB that may include an antenna (or an antenna array) that may include a plurality of antenna elements, which may be provided as antenna patches, for example. Such an antenna (or antenna array) may allow narrow high beam gains, both for transmission and reception of signals. For example, at the UE, there may be a UE DL antenna gain for received DL signals, and a UE UL antenna gain for transmission of UL signals. Likewise, at the gNB, there may be a gNB UL antenna gain for received UL signals, and a gNB DL antenna gain for transmission of DL signals. Therefore, according to an example embodiment, systems may be provided at the UE and/or gNB that may use or may be based on narrow beams, and/or based on multiple antenna patches for example. Each antenna having a X dB gain. For example, a maximum gain may be achieved, at least in some cases, if the beam is pointed or aimed directly towards the other node. The gain will be same in UL and DL if both are pointed to the other wireless node. In an example embodiment, the UE DL and UL antenna gains may be ignored or omitted, as at least in some cases, it may be assumed that these are the same. Thus, any significant difference in UL and DL path loss may, for example, be due to a misalignment of the UE UL transmit beam (UE UL/DL beam correspondence misalignment). In an example embodiment, the calculation and comparison of an UL loss metric and a DL loss metric may be used as a technique to detect such an UL/DL beam correspondence misalignment for the UE.

Therefore, in an example embodiment, an UL/DL beam correspondence misalignment for the UE can thus be detected by comparing these metrics (or a difference of these metrics) against a specified threshold:

|DL_Metric−UL_Metric|≤threshold→UE UL/DL beam correspondence alignment

|DL_Metric−UL_Metric|>threshold→UE UL/DL beam correspondence misalignment

Thus, in an example embodiment, an uplink/downlink beam correspondence misalignment for the UE may be determined (detected) based on: determining an absolute value of a difference between the downlink loss metric and the uplink loss metric; and determining that the absolute value of the difference between the downlink loss metric and the uplink loss metric is greater than a threshold value.

The calculation of a UL loss metric, DL loss metric, and comparison of a difference of such loss metrics to a threshold to determine whether a UE UL/DL beam correspondence misalignment exists may be performed by the UE or by the gNB/BS. For example, a first node that is performing the loss metric calculations may need to receive information from the second node, such as a transmit power used by the second node to transmit reference signals, and a second node measured receive power of the reference signals transmitted by the first node. One or more of these parameters may be used to determine or calculate loss metric(s).

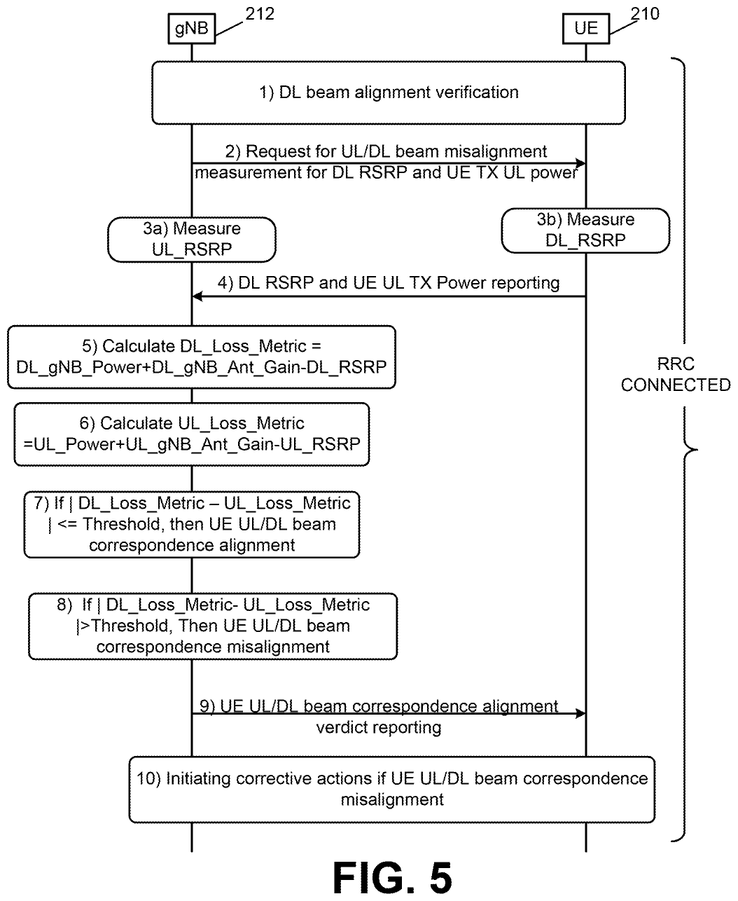

FIG. 5 is a flow chart illustrating a procedure for a base station or gNB to perform calculation of uplink and downlink loss metrics, and to determine an UL/DL beam correspondence misalignment according to an example embodiment. In this case the gNB 212 is performing the loss metric calculations, and the gNB requests the UE 210 to provide (or receives from the UE) a DL RSRP (UE measured DL receive power) measurement result and information indicating the UE UL transmit power level used by the UE to transmit UL reference signals. The operations 1)-10) of FIG. 5 include the following example operations.

1) Pre-verification: As an initial step prior to UL/DL correspondence verification, a UE DL beam alignment verification may be conducted. As an illustrative example, the beam alignment procedure shown in FIG. 2 may be performed to confirm the UE DL beam alignment towards the gNB. Thus, for example, a procedure may be used to confirm that the DL beams are aligned for gNB and UE.

2) gNB: Initiation of measurement. At any given time (e.g., selected by serving gNB) an UL/DL beam misalignment measurement may be initiated by gNB. This may be triggered, for example, based upon gNB experiencing poor UL quality despite a confirmed DL beam alignment. gNB->UE: Measurement request. gNB requests the UE to perform required measurements: (the gNB may transmit DL reference signals to be measured by the UE, and the UE may transmit UL reference signals to be measured by the gNB):
Request for UE to measure and report UE measured DL receive power (e.g., DL RSRP) of the DL reference signals, and the UE UL transmit (TX) power used by the UE to transmit UL reference signals;
The request may include DL/UL RS and/or time configuration, including information on the reference signal (RS) and when the UE shall perform DL RSRP measurements and/or UL RS transmissions.

3b) UE: UE measures the UE measured receive power (DL RSRP) for the DL reference signals received by the UE from the gNB (need to be measured on RS used for logged/recorded gNB DL transmit (TX) power);

3a) gNB: gNB measures the gNB measured UL receive power (UL RSRP) for the UL reference signals received by the gNB from the UE (need to be measured on RS used for logged/recorded UE UL transmit power). For example, the UE measurement of the receive power of the DL reference signals, and the gNB measurement of the receive power of the UL reference signals, should be performed within a channel coherence time period, e.g., to ensure the path losses and/or changes in any of the parameters, as between UL path and DL path, are not due to changes in the channels.

4) UE->gNB: Measurement reporting. The UE reports back to serving gNB the measured UE measured DL receive power (DL_RSRP) and information on the used UL transmit power in transmission of UL RSs.

5-6) gNB: Calculations. gNB calculates the required comparison metrics (DL loss metric, UL loss metric), e.g., based on below listed parameters and arrives at a beam correspondence verdict, indicating whether there is UE UL/DL beam correspondence alignment, or UE UL/DL beam correspondence misalignment. If a UE UL/DL beam correspondence misalignment is determined (e.g., detected), then a corrective action may be performed (e.g., by the UE and/or gNB) to improve alignment between the UE UL transmit beam and the UE DL receive beam.

5) gNB calculates the DL_Loss_Metric as:
a. DL_Loss_Metric=DL_gNB_Power+DL_gNB_Ant_Gain−DL_RSRP

6) gNB calculates the UL_Loss_Metric as:
a. UL_Loss_Metric=UL_Power+UL_gNB_Ant_Gain−UL_RSRP

7-8) gNB determines if UE UL/DL beam correspondence alignment or misalignment:

7) if |DL_Loss_Metric−UL_Loss_Metric|<=threshold->UE UL/DL beam correspondence alignment is preserved;

8) if |DL_Loss_Metric−UL_Loss_Metric|>threshold->there is UE UL/DL beam correspondence misalignment. (UE UL/DL beam correspondence alignment is broken).

9) gNB<->UE: In this case, where the gNB calculates the loss metrics and determines if there is UE UL/DL beam correspondence misalignment, the gNB sends a message to the UE to deliver beam correspondence verdict report to UE (e.g., indicating whether or not there is UE UL/DL beam correspondence alignment).

10) gNB & UE: Initiating Corrective Actions. If a UE UL/DL beam correspondence misalignment is determined (e.g., detected), then a corrective action(s) may be performed (e.g., by the UE and/or gNB) to improve alignment between the UE UL transmit beam and the UE DL receive beam.

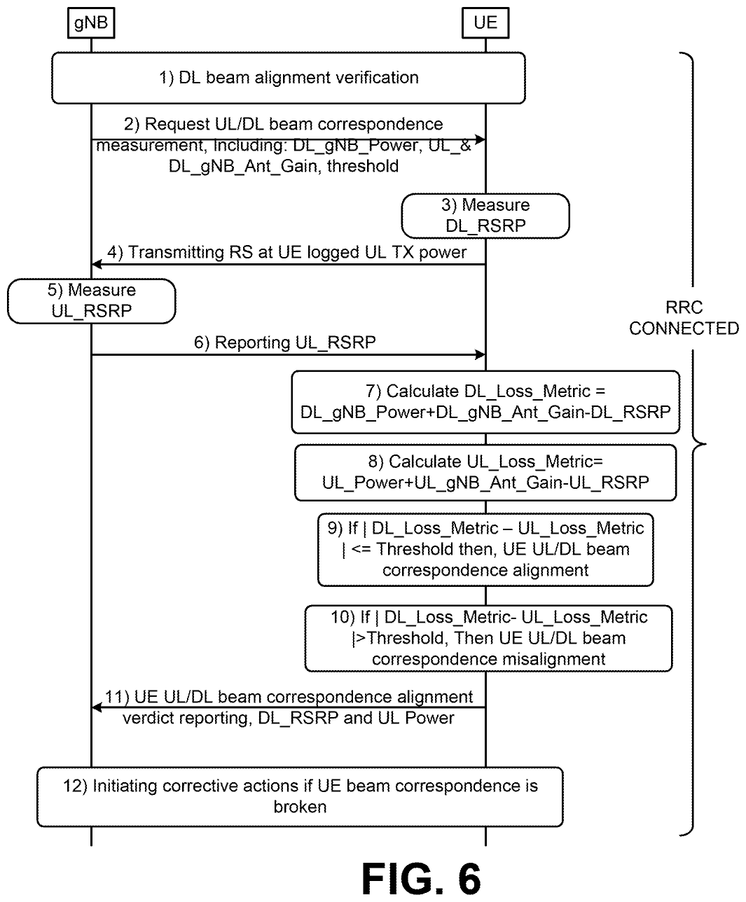

FIG. 6 is a flow chart illustrating a procedure for a user equipment (UE) or user device to perform calculation of uplink and downlink loss metrics, and to determine an UL/DL beam correspondence misalignment according to an example embodiment. Operations 1)-12) are shown in FIG. 6.

1) Pre-verification: As an initial step prior to UL/DL correspondence verification, a UE DL beam alignment verification may be conducted. As an illustrative example, the beam alignment procedure shown in FIG. 2 may be performed to confirm the UE DL beam alignment towards the gNB. Thus, for example, a procedure may be used to confirm that the DL beams are aligned for gNB and UE.

2)gNB: Initiation of measurement. At any given time (e.g., selected by serving gNB) an UL/DL beam misalignment measurement may be initiated by gNB. This may be triggered, for example, based upon gNB experiencing poor UL quality despite a confirmed DL beam alignment.

2) gNB->UE: gNB request for a UE beam correspondence measurement:
The request may include parameters: DL_gNB_Power, UL_ & DL_gNB_Ant_gain and threshold.
The request may also include DL/UL RS and time configuration, including information on the DL/UL RS to be used, and when the UE should perform 4) UL RS transmissions and 3) DL RSRP measurements.

3) UE: The UE measures the DL RSRP (UE measured DL receive power of the DL reference signals), on the DL RS occasions configured in step 2). gNB may then maintain the gNB Tx power constant on the DL RS (reference signal) occasions

4) UE->gNB: The UE transmit RS at UE logged/recorded UL transmit power.

5) gNB: gNB measures the UL RSRP, (gNB measured UL receive power of UL reference signals from UE).

6) gNB->UE: The gNB reports measured UL RSRP to UE.

7) UE: The UE calculates the DL_Loss_Metric as:

DL_Loss_Metric=DL_gNB_Power+DL_gNB_Ant_Gain−DL_RSRP

8) UE: The UE calculates the UL_Loss_Metric as:

UL_Loss_Metric=UL_Power+UL_gNB_Ant_Gain−UL_RSRP

9)-10) UE: The UE compares UL and DL Loss Metrics (e.g., or a difference therebetween) against a predefined Threshold, threshold:

9) if |DL_Loss_Metric−UL_Loss_Metric|<=threshold->UE UL/DL beam correspondence alignment is preserved.

10) if |DL_Loss_Metric−UL_Loss_Metric|>threshold->UE UL/DL beam correspondence misalignment is detected.

11) UE->gNB: The UE send to the gNB a report including UE UL/DL beam correspondence alignment verdict and the used UE parameters DL_RSRP (UE measured receive power for DL reference signals) and UL_Power (UE UL transmit power for UL reference signals).

12) gNB & UE: Initiating Corrective Actions. If a UE UL/DL beam correspondence misalignment is determined (e.g., detected), then a corrective action(s) may be performed (e.g., by the UE and/or gNB) to improve alignment between the UE UL transmit beam and the UE DL receive beam.

The measurements in steps 3) and 5) should be performed within the channel coherence time to ensure the path losses remain identical or constant in UL and DL during measurement.

### Example Reference Signal Configurations

The downlink RSRP measurement can be done by configuring the UE with a Report Setting indicating that L1-RSRP is to be reported and a Resource Setting indicating the particular CSI-RS (channel state information reference signal) or SSB (synchronization signal block)/PBCH (physical broadcast channel) block that is to be measured.

If an SSB/PBCH block is to be used as the DL reference signal, the Resource Setting would indicate the particular SSB/PBCH block that would be best for the UE. However, if a CSI-RS is to be used, the base can transmit a “CSI-RS resource for beam management,” which may be called a “CSI-RS resource in a NZP-CSI-RS-ResourceSet configured with higher layer parameter repetition”. The gNB has two options for which TX beam to use to transmit the CSI-RS: a beam that was used to transmit an SSB/PBCH block (e.g., a wide beam) or a refined beam (e.g., a narrow beam). If the gNB transmits the CSI-RS with a beam that was used to transmit an SSB, the CSI-RS would have a TCI state where DL RS1 is the particular SSB (with QCL TypeC) and DL RS2 is the same SSB (with QCL TypeD) (e.g., the DL-RSx in the TCI state may indicate to the UE that the UE should use the same RX beam that was used to receive the RS indicated in the DL-RSx field of the TCI configuration). If the gNB transmits with a refined beam, the CSI-RS would have a TCI state where DL RS1 is the TRS (with QCL-TypeA) and DL RS2 is the particular CSI-RS for beam management (QCL-TypeD), where the TRS and CSI-RS for beam management are both transmitted out of the refined beam.

The UL RSRP measurement can be done by configuring the UE to transmit SRS (sounding reference signals), such as, for example, aperiodic SRS, where the SRS is configured via RRC and the DCI triggers the SRS resource set to be used. To ensure that the SRS is transmitted with the proper UE TX beam, the SRS would be configured with the parameter spatialRelationlnfo containing the ID of the reference DL RS, which would be either the SS/PBCH or CSI-RS used for the DL RSRP measurement.

### Some Example Features and/or Advantages

Allows detection of a UE UL/DL beam correspondence misalignment, and thus, may allow a corrective action to be performed.

Loss Metrics and UE UL/DL beam correspondence misalignment detection may be performed at either UE or gNB.

At the end of an example beam alignment procedure (e.g., see procedure of FIG. 2, as an example), alignment is obtained between gNB TX beam and UE RX beam. Associated alignment between UE TX beam and gNB RX beam is indirectly assumed by UL/DL beam correspondence. UE UL/DL beam correspondence alignment may be broken (e.g., causing UE UL/DL beam correspondence misalignment, such as the illustrative example shown in case (C) of FIG. 3) under certain scenarios in the field which will impact link performance and cause cell interference if left undetected.

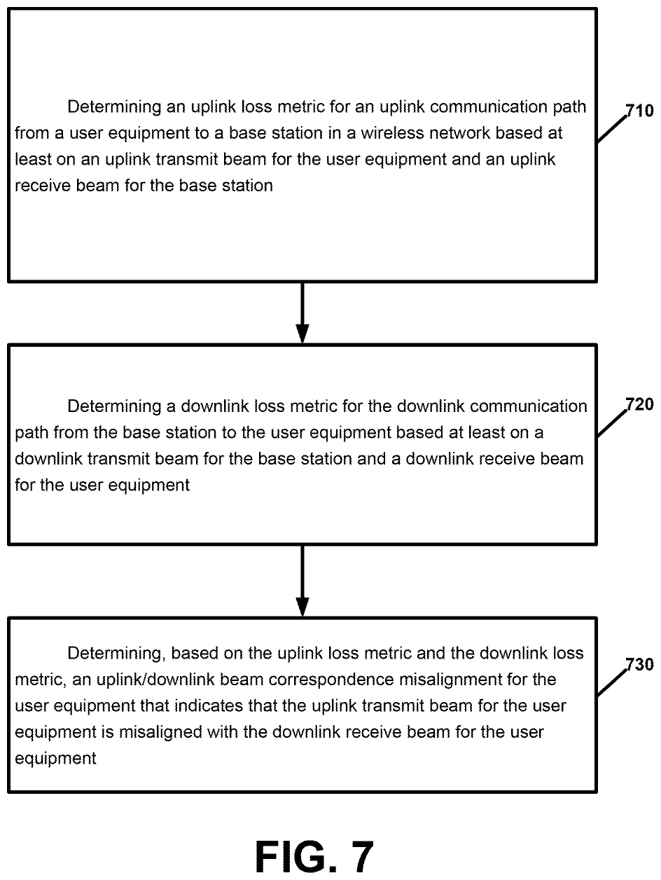

Example 1. FIG. 7 is a flow chart illustrating operation of a wireless node (e.g., gNB/BS, UE/user device, or other wireless node) according to an example embodiment. Operation 710 includes determining an uplink loss metric for an uplink communication path from a user equipment to a base station in a wireless network based at least on an uplink transmit beam for the user equipment and an uplink receive beam for the base station. Operation 720 includes determining a downlink loss metric for the downlink communication path from the base station to the user equipment based at least on a downlink transmit beam for the base station and a downlink receive beam for the user equipment. And, operation 730 includes determining, based on the uplink loss metric and the downlink loss metric, an uplink/downlink beam correspondence misalignment for the user equipment that indicates that the uplink transmit beam for the user equipment is misaligned with the downlink receive beam for the user equipment.

Example 2. The method of example 1, further comprising: receiving a message including at least one of the following: an indication of a measured receive power of reference signals transmitted in a first direction, and a transmit power of reference signals transmitted in a second direction; and wherein at least one of the determining the uplink loss metric and the determining the downlink loss metric is determined, based at least in part, on at least one of the measured receive power of reference signals transmitted in the first direction or the transmit power of reference signals transmitted in the second direction.

Example 3. The method of any of examples 1-2, wherein the determining an uplink/downlink beam correspondence misalignment for the user equipment comprises:

determining an absolute value of a difference between the downlink loss metric and the uplink loss metric; and determining that the absolute value of the difference between the downlink loss metric and the uplink loss metric is greater than a threshold value.

Example 4. The method of any of examples 1-3 wherein the downlink loss metric is determined based at least on a base station transmit power for a downlink transmission of reference signals from the base station, and a user equipment measured receive power of downlink reference signals received by the user equipment from the base station.

Example 5. The method of any of examples 1-4 wherein the uplink loss metric is determined based at least on a user equipment transmit power for an uplink transmission of reference signals from the user equipment, and a base station measured receive power of the uplink reference signals received by the base station from the user equipment.

Example 6. The method of any of examples 1-5, comprising: performing, in response to the determining an uplink/downlink beam correspondence misalignment for the user equipment, a corrective action to improve an alignment between the uplink transmit beam for the user equipment and the downlink receive beam for the user equipment.

In an example embodiment, the operations of examples 1-6 may be performed by UE or user device, e.g., see FIG. 6 as an example. In another example embodiment, the operations of examples 1-6 may be performed by a BS/gNB, e.g., see FIG. 5 as an example.

Example 7. The method of any of examples 1-6, further comprising: transmitting, by the base station, downlink reference signals; receiving, by the base station from the user equipment, uplink reference signals; determining a base station transmit power used by the base station to transmit the downlink reference signals; receiving, by the base station from the user equipment, information indicating a user equipment measured receive power of the downlink reference signals received by the user equipment from the base station, and a user equipment transmit power used to transmit the uplink reference signals; and determining, by the base station, a base station measured receive power of the uplink reference signals received by the base station from the user equipment.

Example 8. The method of any of examples 1-7, wherein the determining an uplink loss metric comprises determining, by the base station, an uplink loss metric based, at least in part, on the user equipment transmit power for uplink reference signals and the base station measured receive power of the uplink reference signals; wherein the determining a downlink loss metric comprises determining, by the base station, a downlink loss metric based, at least in part, on the base station transmit power used by the base station to transmit the downlink reference signals and the user equipment measured receive power of the downlink reference signals.

Example 9. The method of any of examples 1-8 further comprising: determining an uplink antenna gain used by the base station to receive the uplink reference signals from the user equipment; determining a downlink antenna gain used by the base station to transmit the downlink reference signals; wherein the determining an uplink loss metric comprises determining, by the base station, an uplink loss metric based, at least in part, on the user equipment transmit power for uplink reference signals, the uplink antenna gain for the base station, and the base station measured receive power of the uplink reference signals; wherein the determining a downlink loss metric comprises determining, by the base station, a downlink loss metric based, at least in part, on the base station transmit power used by the base station to transmit the downlink reference signals, the downlink antenna gain for the base station, and the user equipment measured receive power of the downlink reference signals.

Example 10. The method of any of examples 1-6, further comprising: sending, by the user equipment, uplink reference signals; receiving, by the user equipment from the base station, downlink reference signals; receiving, by the user equipment from the base station, information indicating a base station measured receive power of the uplink reference signals received by the base station from the user equipment, and a base station transmit power for downlink reference signals; and determining, by the user equipment, a user equipment measured receive power of the downlink reference signals.

Example 11. The method of any of examples 1-6 and 10: wherein the determining an uplink loss metric comprises determining, by the user equipment, an uplink loss metric based, at least in part, on the user equipment transmit power for uplink reference signals minus the base station measured receive power of the uplink reference signals; wherein the determining a downlink loss metric comprises determining, by the user equipment, a downlink loss metric based, at least in part, on the base station transmit power used by the base station to transmit the downlink reference signals minus the user equipment measured receive power of the downlink reference signals.

Example 12. The method of any of examples 1-6 and 10-11, further comprising: receiving, by the user equipment from the base station, information indicating an uplink antenna gain used by the base station to receive the uplink reference signals from the user equipment, and a downlink antenna gain used by the base station to transmit the downlink reference signals; wherein the determining an uplink loss metric comprises determining, by the base station, an uplink loss metric based, at least in part, on the user equipment transmit power for uplink reference signals, the uplink antenna gain for the base station, and the base station measured receive power of the uplink reference signals; wherein the determining a downlink loss metric comprises determining, by the base station, a downlink loss metric based, at least in part, on the base station transmit power used by the base station to transmit the downlink reference signals, the downlink antenna gain for the base station, and the user equipment measured receive power of the downlink reference signals.

Example 13. The method of any of examples 1-6 and 10-12, further comprising: sending, by the user equipment to the base station, a message reporting the uplink/downlink beam correspondence misalignment for the user equipment.

Example 14. The method of any of examples 1-13, further comprising: sending or receiving a message including a threshold value to be used in the determining of the uplink/downlink beam correspondence misalignment for the user equipment based on an absolute value of a difference between the downlink loss metric and the uplink loss metric being greater than the threshold value.

Example 15. An apparatus comprising means for performing the method of any of examples 1-14.

Example 16. A non-transitory computer-readable storage medium comprising instructions stored thereon that, when executed by at least one processor, are configured to cause a computing system to perform the method of any of examples 1-14.

Example 17. An apparatus comprising: at least one processor; and at least one memory including computer program code; the at least one memory and the computer program code configured to, with the at least one processor, cause the apparatus at least to perform the method of any of examples 1-14.

Example 18. The method of any of examples 1-6, wherein the determining an uplink loss metric, determining a downlink loss metric, and determining an uplink/downlink beam correspondence misalignment for the user equipment are performed by the base station.

Example 19. The method of any of examples 1-6, wherein the determining an uplink loss metric, determining a downlink loss metric, and determining an uplink/downlink beam correspondence misalignment for the user equipment are performed by the user equipment.

Example 20. The method of any of examples 1-9 and 14, further comprising: sending, by the base station to the user equipment, a threshold value to be used in the determining of the uplink/downlink beam correspondence misalignment for the user equipment based on an absolute value of a difference between the downlink loss metric and the uplink loss metric being greater than the threshold value.

Example 21. The method of any of examples 1-6, and 10-14, further comprising: receiving, by the user equipment from the base station, a threshold value to be used in the determining of the uplink/downlink beam correspondence misalignment for the user equipment based on an absolute value of a difference between the downlink loss metric and the uplink loss metric being greater than the threshold value.

Example 22. The method of any of examples 1-6, 10-14 and 21, comprising: performing, by the user equipment prior to determining the uplink loss metric and the downlink loss metric, a beam realignment procedure to determine the downlink receive beam for the user equipment that is aligned with the downlink transmit beam of the base station.

Example 23. The method of any of examples 1-9 and 14, comprising: performing, by the base station, in response to the determining an uplink/downlink beam correspondence misalignment for the user equipment, a corrective action to improve an alignment between the uplink transmit beam for the user equipment and the downlink receive beam for the user equipment.

Example 24. The method of any of examples 1-6, 10-14 and 21, comprising: performing, by the user equipment, in response to the determining an uplink/downlink beam correspondence misalignment for the user equipment, a corrective action to improve an alignment between the uplink transmit beam for the user equipment and the downlink receive beam for the user equipment.

Example 25. The method of example 24, wherein the performing a corrective action comprises the following: transmitting, by the user equipment to the base station, uplink reference signals via a plurality of uplink transmit beams; and receiving, by the user equipment from the base station based on measurements of the uplink reference signals, information indicating a strongest or best uplink transmit beam for the user equipment.

Example 26. The method of example 6, wherein the performing a corrective action comprises the following: receiving, by the base station from the user equipment, uplink reference signals via a plurality of uplink transmit beams; determining, by the base station, a strongest or best uplink transmit beam for the user equipment; and sending, by the base station to the user equipment, information indicating the strongest or best uplink transmit beam for the user equipment.

Example 27. The method of any of examples 1-9, 14 and 26: wherein the determining an uplink loss metric comprises determining, by the base station, an uplink loss metric based, at least in part, on a difference between the user equipment transmit power for uplink reference signals and the base station measured receive power of the uplink reference signals; wherein the determining a downlink loss metric comprises determining, by the base station, a downlink loss metric based, at least in part, on a difference between a base station transmit power used by the base station to transmit the downlink reference signals and the user equipment measured receive power of the downlink reference signals.

Example 28. The method of any of examples 1-9, 14 and 26, comprising: determining an uplink antenna gain used by the base station to receive the uplink reference signals from the user equipment; determining a downlink antenna gain used by the base station to transmit the downlink reference signals; wherein the determining an uplink loss metric comprises determining, by the base station, an uplink loss metric based on: (the user equipment transmit power for uplink reference signals plus the uplink antenna gain for the base station) minus (the base station measured receive power of the uplink reference signals); wherein the determining a downlink loss metric comprises determining, by the base station, a downlink loss metric based on: (the base station transmit power used by the base station to transmit the downlink reference signals plus the downlink antenna gain for the base station) minus (the user equipment measured receive power of the downlink reference signals).

Example 29. The method of any of examples 1-6, comprising: sending or receiving a request for an uplink/downlink beam correspondence misalignment measurement for the user equipment.

Example 30. The method of any of examples 1-9, comprising: sending, by the base station to the user equipment, a request for an uplink/downlink beam correspondence misalignment measurement for the user equipment.

Example 31. The method of any of examples 1-6, and 10-14, comprising: receiving, by the user equipment from the base station, a request for an uplink/downlink beam correspondence misalignment measurement for the user equipment.

Example 32. The method of any of examples 1-6, further comprising: sending or receiving a message reporting the uplink/downlink beam correspondence misalignment for the user equipment.

Example 33. The method of any of examples 1-9, further comprising: sending, by the base station to the user equipment, a message reporting the uplink/downlink beam correspondence misalignment for the user equipment.

Example 34. The method of any of examples 1-6, and 10-14, comprising: receiving, by the user equipment from the base station, a message reporting the uplink/downlink beam correspondence misalignment for the user equipment.

Example 35. The method of any of examples 1-6, and 10-14, wherein the determining an uplink loss metric comprises determining, by the user equipment, an uplink loss metric based, at least in part, on a difference between the user equipment transmit power for uplink reference signals and the base station measured receive power of the uplink reference signals; and, wherein the determining a downlink loss metric comprises determining, by the user equipment, a downlink loss metric based, at least in part, on a difference between the base station transmit power used by the base station to transmit the downlink reference signals and the user equipment measured receive power of the downlink reference signals.

Example 36. The method of any of examples 1-6, 10-14 and 35, further comprising:
wherein the determining an uplink loss metric comprises determining, by the user equipment, an uplink loss metric based on: (the user equipment transmit power for uplink reference signals plus the uplink antenna gain for the base station) minus (the base station measured receive power of the uplink reference signals); wherein the determining a downlink loss metric comprises determining, by the user equipment, a downlink loss metric based on: (the base station transmit power used by the base station to transmit the downlink reference signals plus the downlink antenna gain for the base station) minus (the user equipment measured receive power of the downlink reference signals).

Example 37. An apparatus comprising means for performing the method of any of examples 1-14, and 18-36.

Example 38. A non-transitory computer-readable storage medium comprising instructions stored thereon that, when executed by at least one processor, are configured to cause a computing system to perform the method of any of examples 1-14, and 18-36.

Example 39. A computer program comprising instructions stored thereon for performing the method of any of examples 1-14, and 18-36.

Example 40. A computer readable medium of wireless communication storing a program of instructions, execution of which by a processor configuring an apparatus to perform the method of any of examples 1-14, and 18-36.

Example 41. An apparatus comprising: at least one processor; and at least one memory including computer program code; the at least one memory and the computer program code configured to, with the at least one processor, cause the apparatus at least to perform the method of any of examples 1-14, and 18-36.

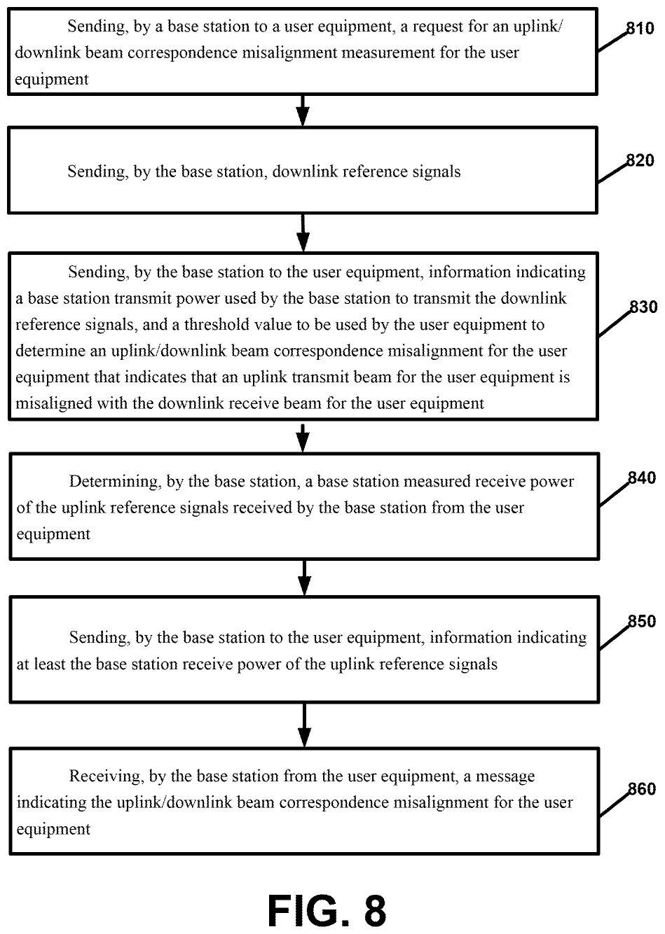

Example 42. FIG. 8 is a flow chart illustrating operation of a base station according to another example embodiment. Operation 810 includes sending, by a base station to a user equipment, a request for an uplink/downlink beam correspondence misalignment measurement for the user equipment. Operation 820 includes sending, by the base station, downlink reference signals. Operation 830 includes sending, by the base station to the user equipment, information indicating a base station transmit power used by the base station to transmit the downlink reference signals, and a threshold value to be used by the user equipment to determine an uplink/downlink beam correspondence misalignment for the user equipment that indicates that an uplink transmit beam for the user equipment is misaligned with the downlink receive beam for the user equipment. Operation 840 includes determining, by the base station, a base station measured receive power of the uplink reference signals received by the base station from the user equipment. Operation 850 includes sending, by the base station to the user equipment, information indicating at least the base station receive power of the uplink reference signals. Operation 860 includes receiving, by the base station from the user equipment, a message indicating the uplink/downlink beam correspondence misalignment for the user equipment.

Example 43. The method of example 42, further comprising: performing, by the base station, in response to receiving the message indicating an uplink/downlink beam correspondence misalignment for the user equipment, a corrective action to improve an alignment between the uplink transmit beam for the user equipment and the downlink receive beam for the user equipment.

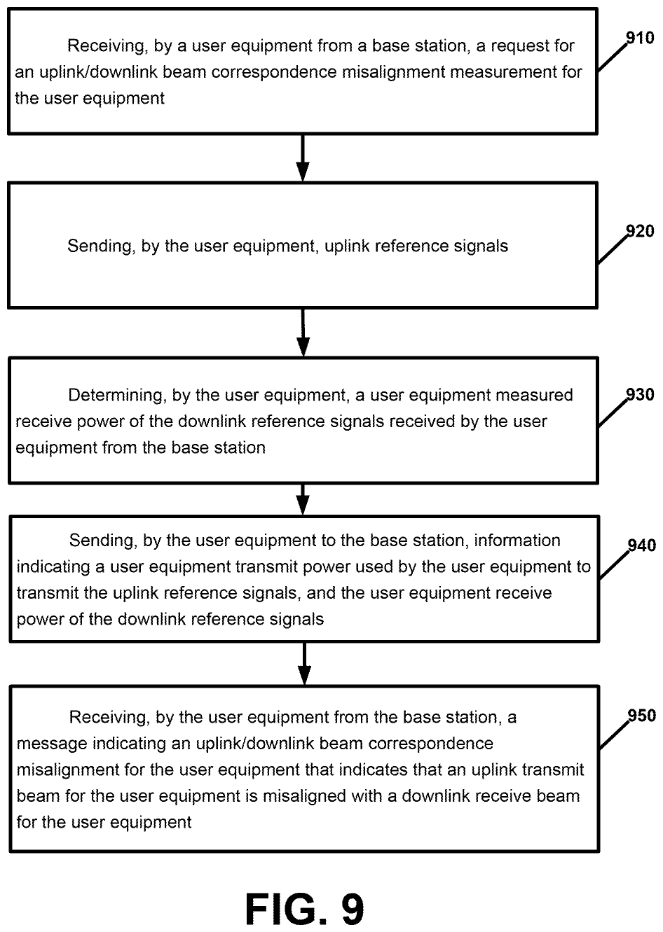

Example 44. FIG. 9 is a flow chart illustrating operation of a user device/UE according to another example embodiment. Operation 910 includes receiving, by a user equipment from a base station, a request for an uplink/downlink beam correspondence misalignment measurement for the user equipment. Operation 920 includes sending, by the user equipment, uplink reference signals. Operation 930 includes determining, by the user equipment, a user equipment measured receive power of the downlink reference signals received by the user equipment from the base station. Operation 940 includes sending, by the user equipment to the base station, information indicating a user equipment transmit power used by the user equipment to transmit the uplink reference signals, and the user equipment receive power of the downlink reference signals. Operation 950 includes receiving, by the user equipment from the base station, a message indicating an uplink/downlink beam correspondence misalignment for the user equipment that indicates that an uplink transmit beam for the user equipment is misaligned with a downlink receive beam for the user equipment (or indicating UE UL/DL beam correspondence misalignment for the UE).

Example 45. The method of example 44, further comprising: receiving, by the user equipment from the base station, information indicating an uplink antenna gain of the base station and a downlink antenna gain of the base station.

Example 46. The method of any of examples 44-45, further comprising: performing, by the user equipment, in response to receiving the message indicating an uplink/downlink beam correspondence misalignment for the user equipment, a corrective action to improve an alignment between the uplink transmit beam for the user equipment and the downlink receive beam for the user equipment.

Example 47. An apparatus comprising means for performing the method of any of examples 42-43.

Example 48. A non-transitory computer-readable storage medium comprising instructions stored thereon that, when executed by at least one processor, are configured to cause a computing system to perform the method of any of examples 42-43.

Example 49. An apparatus comprising: at least one processor; and at least one memory including computer program code; the at least one memory and the computer program code configured to, with the at least one processor, cause the apparatus at least to perform the method of any of examples 42-43.

Example 50. An apparatus comprising means for performing the method of any of examples 44-46.

Example 51. A non-transitory computer-readable storage medium comprising instructions stored thereon that, when executed by at least one processor, are configured to cause a computing system to perform the method of any of examples 44-46.

Example 52. An apparatus comprising: at least one processor; and at least one memory including computer program code; the at least one memory and the computer program code configured to, with the at least one processor, cause the apparatus at least to perform the method of any of examples 44-46.

Example 53. An apparatus comprising: at least one processor; and at least one memory including computer program code; the at least one memory and the computer program code configured to, with the at least one processor, cause the apparatus at least to: determine an uplink loss metric for an uplink communication path from a user equipment to a base station in a wireless network based at least on an uplink transmit beam for the user equipment and an uplink receive beam for the base station; determine a downlink loss metric for the downlink communication path from the base station to the user equipment based at least on a downlink transmit beam for the base station and a downlink receive beam for the user equipment; and determine, based on the uplink loss metric and the downlink loss metric, an uplink/downlink beam correspondence misalignment for the user equipment that indicates that the uplink transmit beam for the user equipment is misaligned with the downlink receive beam for the user equipment.

Example 54. The apparatus of example 53, wherein the at least one memory and the computer program code configured to, with the at least one processor, cause the apparatus further to: receive a message including at least one of the following: an indication of a measured receive power of reference signals transmitted in a first direction, and a transmit power of reference signals transmitted in a second direction; and wherein at least one of the determining the uplink loss metric and the determining the downlink loss metric is determined, based at least in part, on at least one of the measured receive power of reference signals transmitted in the first direction or the transmit power of reference signals transmitted in the second direction.

Example 55. The apparatus of example 53, wherein being configured to cause the apparatus to determine an uplink/downlink beam correspondence misalignment for the user equipment comprises the at least one memory and the computer program code configured to, with the at least one processor, cause the apparatus to: determine an absolute value of a difference between the downlink loss metric and the uplink loss metric; and determine that the absolute value of the difference between the downlink loss metric and the uplink loss metric is greater than a threshold value.

Example 56. The apparatus of example 53 wherein: the downlink loss metric is determined based at least on a base station transmit power for a downlink transmission of reference signals from the base station, and a user equipment measured receive power of downlink reference signals received by the user equipment from the base station; and, the uplink loss metric is determined based at least on a user equipment transmit power for an uplink transmission of reference signals from the user equipment, and a base station measured receive power of the uplink reference signals received by the base station from the user equipment.

Example 57. The apparatus of example 53, wherein the at least one memory and the computer program code configured to, with the at least one processor, cause the apparatus further to: perform, in response to the determining an uplink/downlink beam correspondence misalignment for the user equipment, a corrective action to improve an alignment between the uplink transmit beam for the user equipment and the downlink receive beam for the user equipment.

Example 58. The apparatus of example 53, wherein the at least one memory and the computer program code configured to, with the at least one processor, cause the apparatus further to: send or receive a message including a threshold value to be used in the determining of the uplink/downlink beam correspondence misalignment for the user equipment based on an absolute value of a difference between the downlink loss metric and the uplink loss metric being greater than the threshold value.

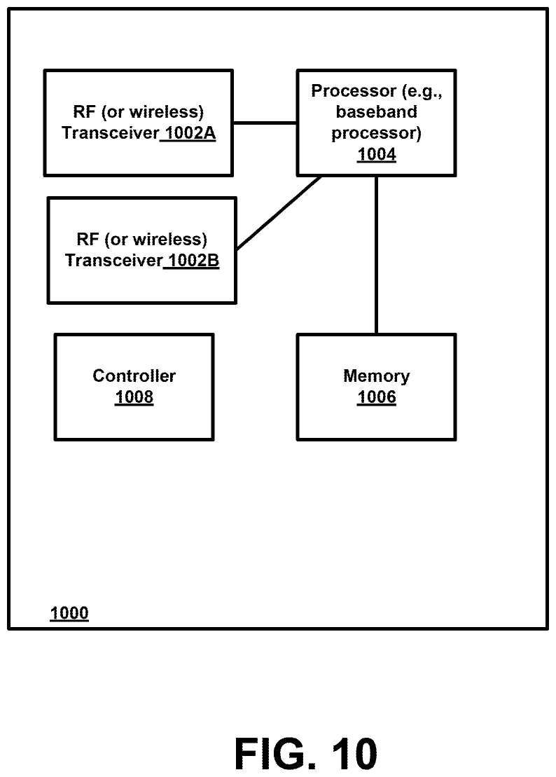

FIG. 10 is a block diagram of a wireless station or wireless node (e.g., AP, BS or user device/UE, relay station or other node) 1000 according to an example embodiment. The wireless station 1000 may include, for example, one or more (e.g., two as shown in FIG. 10) RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 10, a controller (or processor) 1008 may execute software and instructions, and may provide overall control for the station 1000, and may provide control for other systems not shown in FIG. 10, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example embodiment, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks may use network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Example embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
determining an uplink loss metric for an uplink communication path from a user equipment to a base station in a wireless network based at least on an uplink transmit beam for the user equipment and an uplink receive beam for the base station;
determining a downlink loss metric for the downlink communication path from the base station to the user equipment based at least on a downlink transmit beam for the base station and a downlink receive beam for the user equipment; and
determining, based on the uplink loss metric and the downlink loss metric, an uplink/downlink beam correspondence misalignment for the user equipment that indicates that the uplink transmit beam for the user equipment is misaligned with the downlink receive beam for the user equipment.

2. The method of claim 1, further comprising:
receiving a message including at least one of the following: an indication of a measured receive power of reference signals transmitted in a first direction, and a transmit power of reference signals transmitted in a second direction; and
wherein at least one of the determining the uplink loss metric and the determining the downlink loss metric is determined, based at least in part, on at least one of the measured receive power of reference signals transmitted in the first direction or the transmit power of reference signals transmitted in the second direction.

3. The method of claim 1, wherein the determining an uplink/downlink beam correspondence misalignment for the user equipment comprises:
determining an absolute value of a difference between the downlink loss metric and the uplink loss metric; and
determining that the absolute value of the difference between the downlink loss metric and the uplink loss metric is greater than a threshold value.

4. The method of claim 1 wherein the downlink loss metric is determined based at least on a base station transmit power for a downlink transmission of reference signals from the base station, and a user equipment measured receive power of downlink reference signals received by the user equipment from the base station.

5. The method of claim 1 wherein the uplink loss metric is determined based at least on a user equipment transmit power for an uplink transmission of reference signals from the user equipment, and a base station measured receive power of the uplink reference signals received by the base station from the user equipment.

6. The method of claim 1, comprising:
performing, in response to the determining an uplink/downlink beam correspondence misalignment for the user equipment, a corrective action to improve an alignment between the uplink transmit beam for the user equipment and the downlink receive beam for the user equipment.

7. The method of claim 1, further comprising:
transmitting, by the base station, downlink reference signals;
receiving, by the base station from the user equipment, uplink reference signals;
determining a base station transmit power used by the base station to transmit the downlink reference signals;
receiving, by the base station from the user equipment, information indicating a user equipment measured receive power of the downlink reference signals received by the user equipment from the base station, and a user equipment transmit power used to transmit the uplink reference signals; and
determining, by the base station, a base station measured receive power of the uplink reference signals received by the base station from the user equipment.

8. The method of claim 7 wherein the determining an uplink loss metric comprises determining, by the base station, an uplink loss metric based, at least in part, on the user equipment transmit power for uplink reference signals and the base station measured receive power of the uplink reference signals;
wherein the determining a downlink loss metric comprises determining, by the base station, a downlink loss metric based, at least in part, on the base station transmit power used by the base station to transmit the downlink reference signals and the user equipment measured receive power of the downlink reference signals.

9. The method of claim 7 further comprising:
determining an uplink antenna gain used by the base station to receive the uplink reference signals from the user equipment;
determining a downlink antenna gain used by the base station to transmit the downlink reference signals;
wherein the determining an uplink loss metric comprises determining, by the base station, an uplink loss metric based, at least in part, on the user equipment transmit power for uplink reference signals, the uplink antenna gain for the base station, and the base station measured receive power of the uplink reference signals;
wherein the determining a downlink loss metric comprises determining, by the base station, a downlink loss metric based, at least in part, on the base station transmit power used by the base station to transmit the downlink reference signals, the downlink antenna gain for the base station, and the user equipment measured receive power of the downlink reference signals.

10. The method of claim 1, comprising:
sending, by the user equipment, uplink reference signals;
receiving, by the user equipment from the base station, downlink reference signals;
receiving, by the user equipment from the base station, information indicating a base station measured receive power of the uplink reference signals received by the base station from the user equipment, and a base station transmit power for downlink reference signals; and
determining, by the user equipment, a user equipment measured receive power of the downlink reference signals.

11. The method of claim 10:
wherein the determining an uplink loss metric comprises determining, by the user equipment, an uplink loss metric based, at least in part, on the user equipment transmit power for uplink reference signals minus the base station measured receive power of the uplink reference signals;
wherein the determining a downlink loss metric comprises determining, by the user equipment, a downlink loss metric based, at least in part, on the base station transmit power used by the base station to transmit the downlink reference signals minus the user equipment measured receive power of the downlink reference signals.

12. The method of claim 10, further comprising:
receiving, by the user equipment from the base station, information indicating an uplink antenna gain used by the base station to receive the uplink reference signals from the user equipment, and a downlink antenna gain used by the base station to transmit the downlink reference signals;
wherein the determining an uplink loss metric comprises determining, by the base station, an uplink loss metric based, at least in part, on the user equipment transmit power for uplink reference signals, the uplink antenna gain for the base station, and the base station measured receive power of the uplink reference signals;
wherein the determining a downlink loss metric comprises determining, by the base station, a downlink loss metric based, at least in part, on the base station transmit power used by the base station to transmit the downlink reference signals, the downlink antenna gain for the base station, and the user equipment measured receive power of the downlink reference signals.

13. The method of claim 1, further comprising:
sending, by the user equipment to the base station, a message reporting the uplink/downlink beam correspondence misalignment for the user equipment.

14. The method of claim 1, further comprising:
sending or receiving a message including a threshold value to be used in the determining of the uplink/downlink beam correspondence misalignment for the user equipment based on an absolute value of a difference between the downlink loss metric and the uplink loss metric being greater than the threshold value.

15. An apparatus comprising:
at least one processor; and
at least one memory including computer program code;
the at least one memory and the computer program code configured to, with the at least one processor, cause the apparatus at least to:
determine an uplink loss metric for an uplink communication path from a user equipment to a base station in a wireless network based at least on an uplink transmit beam for the user equipment and an uplink receive beam for the base station;
determine a downlink loss metric for the downlink communication path from the base station to the user equipment based at least on a downlink transmit beam for the base station and a downlink receive beam for the user equipment; and
determine, based on the uplink loss metric and the downlink loss metric, an uplink/downlink beam correspondence misalignment for the user equipment that indicates that the uplink transmit beam for the user equipment is misaligned with the downlink receive beam for the user equipment.

16. The apparatus of claim 15, the at least one memory and the computer program code configured to, with the at least one processor, cause the apparatus further to:
receive a message including at least one of the following: an indication of a measured receive power of reference signals transmitted in a first direction, and a transmit power of reference signals transmitted in a second direction; and
wherein at least one of the determining the uplink loss metric and the determining the downlink loss metric is determined, based at least in part, on at least one of the measured receive power of reference signals transmitted in the first direction or the transmit power of reference signals transmitted in the second direction.

17. The apparatus of claim 15, wherein being configured to cause the apparatus to determine an uplink/downlink beam correspondence misalignment for the user equipment comprises the at least one memory and the computer program code configured to, with the at least one processor, cause the apparatus to:
determine an absolute value of a difference between the downlink loss metric and the uplink loss metric; and
determine that the absolute value of the difference between the downlink loss metric and the uplink loss metric is greater than a threshold value.

18. The apparatus of claim 15 wherein:
the downlink loss metric is determined based at least on a base station transmit power for a downlink transmission of reference signals from the base station, and a user equipment measured receive power of downlink reference signals received by the user equipment from the base station; and
the uplink loss metric is determined based at least on a user equipment transmit power for an uplink transmission of reference signals from the user equipment, and a base station measured receive power of the uplink reference signals received by the base station from the user equipment.

19. The apparatus of claim 15, wherein the at least one memory and the computer program code configured to, with the at least one processor, cause the apparatus further to:
perform, in response to the determining an uplink/downlink beam correspondence misalignment for the user equipment, a corrective action to improve an alignment between the uplink transmit beam for the user equipment and the downlink receive beam for the user equipment.

20. The apparatus of claim 15, wherein the at least one memory and the computer program code configured to, with the at least one processor, cause the apparatus further to:
send or receive a message including a threshold value to be used in the determining of the uplink/downlink beam correspondence misalignment for the user equipment based on an absolute value of a difference between the downlink loss metric and the uplink loss metric being greater than the threshold value.
